(19) United States
(12) Patent Application Publication
(10) Pub. No.: US 2015/0219682 A1
(43) Pub. Date: Aug. 6, 2015

(54) GAMIFICATION OF AN EVENT

(71) Applicants: Thomas A. Lasko, Nashville, TN (US); Daniel J. Lasko, South Jordan, UT (US)

(72) Inventors: Thomas A. Lasko, Nashville, TN (US); Daniel J. Lasko, South Jordan, UT (US)

(21) Appl. No.: 14/610,883

(22) Filed: Jan. 30, 2015

Related U.S. Application Data
(60) Provisional application No. 61/934,266, filed on Jan. 31, 2014.

(51) Int. Cl. G01P 15/00; A63F 13/71; A63F 13/213

(52) U.S. Cl. CPC G01P 15/00; A63F 13/213; A63F 13/71

(57) ABSTRACT

A method for verifying user participation includes generating a motion signature associated with an event. The motion signature is generated on a mobile device with a user during the event. The mobile device includes one or more sensors configured to detect motion. The method includes comparing the generated motion signature with a predefined motion signature associated with the event. The predefined motion signature is stored in an event library that includes a plurality of predefined motion signatures, where each predefined motion signature is associated with an event. The method includes verifying that the user participated in the event by verifying that the generated motion signature matches the predefined motion signature of the event.

### CROSS-REFERENCES TO RELATED APPLICATIONS

This application claims the benefit of U.S. Provisional Patent Application No. 61/934,266 entitled “GAMIFICATION OF AN EVENT” and filed on Jan. 31, 2014 for Thomas A. Lasko, et al., which is incorporated herein by reference.

### FIELD

This invention relates to event tracking and more particularly relates to using information from a mobile device to determine if events have been completed.

### BACKGROUND

Cellular telephones, such as smartphones, include numerous sensors and capabilities, such as global positioning satellite (“GPS”) tracking, accelerometers, altimeters, internet capabilities, local wireless network connectability (such as “WI-FI”), etc. The sensors and other capabilities open up endless possibilities for application programmers. Gaming using smartphones has become popular, and the sensors and capabilities of smartphones allows for advanced gaming beyond typical video games.

### SUMMARY

A method for gaming is disclosed. An apparatus and computer program product also perform the functions of the method. The method, in one embodiment, includes generating a motion signature associated with an event. The motion signature is generated on a mobile device with a user during the event. The mobile device includes one or more sensors configured to detect motion. The method includes, in the embodiment, comparing the generated motion signature with a predefined motion signature associated with the event. The predefined motion signature is stored in an event library that includes a plurality of predefined motion signatures, where each predefined motion signature is associated with an event. The method includes, in the embodiment, verifying that the user participated in the event by verifying that the generated motion signature matches the predefined motion signature of the event.

In one embodiment, verifying the generated motion signature matches the predefined motion signature includes performing a probability analysis, where the motion signatures match in response to a result of the probability analysis being within a predetermined threshold. In another embodiment, the one or more sensors include motion sensors and the motion sensors include an accelerometer, a magnetometer, and/or a gyroscope.

In one example, the method includes determining a location of the mobile device using device location functionality of the mobile device, where the generated motion signature is associated with one or more locations. In the embodiment, the method includes comparing the determined location with one or more locations stored in the event library and associated with the event. The event library includes a plurality of locations associated with a plurality of events where each location is associated with a predefined motion signature of an event. In the embodiment, verifying the user participated in the event includes verifying that the generated motion signature matches the predefined motion signature and verifying that at least one of the determined locations matches a location associated with the predefined motion signature of the event.

In another example, the method includes capturing one or more images with an image capture device operably coupled to the mobile device. The one or more captured images are associated with the event. In the example, the method includes comparing the one or more captured images with one or more images stored in the event library and associated with the event. The event library includes a plurality of images associated with a plurality of events where each image is associated with a predefined motion signature of an event. In the example, verifying the user participated in the event includes verifying that the generated motion signature matches the predefined motion signature and verifying that at least one of the one or more captured images matches an image of the event library and associated with the predefined motion signature of the event.

In another embodiment, the method includes capturing one or more audio tracks using an audio capture device operably coupled to the mobile device, where the one or more captured audio tracks are associated with the event. In the embodiment, the method includes comparing the one or more captured audio tracks with one or more audio tracks stored in the event library and associated with the event. The event library includes a plurality of audio tracks associated with a plurality of events wherein each audio track is associated with a predefined motion signature of an event. In the embodiment, verifying the user participated in the event includes verifying that the generated motion signature matches the predefined motion signature and verifying that at least a portion of one of the one or more captured audio tracks matches at least a portion of an audio track associated with the predefined motion signature of the event.

In one example, the method includes selecting a sensor of the one or more sensors based on a type of event experienced by the user. In another embodiment, the method includes determining a timestamp for the event, where the timestamp is associated with the motion signature. In various embodiments, verifying the user participated in the event includes verifying that the generated motion signature matches the predefined motion signature and any combination of verifying that at least one of the determined locations matches a location associated with the predefined motion signature of the event, verifying that at least one of the one or more generated captured matches an image of the event library and associated with the predefined motion signature of the event, verifying that at least a portion of one of the one or more captured audio tracks matches at least a portion of an audio track associated with the predefined motion signature of the event, and determining a timestamp for the event.

An apparatus for gaming includes, in one embodiment, a sensor module that generates a motion signature associated with an event. The motion signature is generated on a mobile device with a user during the event. The mobile device includes one or more sensors configured to detect motion. The apparatus includes, in one embodiment, a match module that compares the generated motion signature with a predefined motion signature associated with the event. The predefined motion signature is stored in an event library that includes a plurality of predefined motion signatures. The apparatus includes, in one embodiment, a validation module that verifies that the user participated in the event by verifying that the generated motion signature matches the predefined motion signature of the event.

In another embodiment, the apparatus includes a story module that presents a first scenario of a story on a mobile device of a user, where the first scenario is associated with the event and is presented to the user prior to the sensor module generating the motion signature. In another embodiment, the event is a first event and a second scenario of the story is presented on the mobile device in response to verifying the generated motion signature matches the predefined motion signature for the first event. The second scenario is associated with a second event and the sensor module, the match module and the validation module verify that the user participated in the second event. Additional scenarios may be presented that are associated with additional events. In another embodiment, the story includes a shared story involving a plurality of users, where the story is being advanced in response to each of the plurality of users participating in an event.

In one embodiment, the apparatus includes a game module that presents a game associated with one or more events. The game is being played by participating in the one or more events, where participation is determined based on generated motion signatures. In a further embodiment, the apparatus includes a score module that tracks the user's scores associated with the game. The user's scores are compared with other users' scores for the game. In another embodiment, the predefined motion signature includes a pre-recorded motion signature for the event. In another embodiment, the predefined motion signature includes a synthetic motion signature for the event, the synthetic motion signature being generated based on one or more of a mathematical formula, an algorithm, and a simulation, and/or a motion signature generated in real-time during the event. In another embodiment, the apparatus includes an action module that performs one or more actions in response to verifying the generated motion signature matches the predefined motion signature.

A computer program product for verifying user participation in a game is described, and the computer program product includes a computer readable storage medium having program code embodied therein. The program code is executable by a processor for generating a motion signature associated with an event. The motion signature is generated on a mobile device with a user during the event, where the mobile device includes one or more sensors configured to detect motion. The program code is executable by a processor, in one embodiment, for comparing the generated motion signature with a predefined motion signature associated with the event, where the predefined motion signature is stored in an event library that includes a plurality of predefined motion signatures, and verifying the user participated in the event by verifying that the generated motion signature matches the predefined motion signature of the event.

In one embodiment, the program code is further executable for presenting a game associated with one or more events, where the game being played by participating in the one or more events, and where participation is determined based on generated motion signatures, and tracking the user's scores associated with the game, where the user's scores are compared with other users' scores for the game. In another embodiment, the event is a first event and the program code further configured for presenting a first scenario of a story on a mobile device of a user. The first scenario is associated with an event prior to generating the motion signature. In the embodiment, the program code is further executable for presenting a second scenario of the story on the mobile device in response to verifying the generated motion signature matches the predefined motion signature. The second scenario is associated with a second event, and the program code is further configured for verifying that the user participated in the second event.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention, and are not therefore to be considered to be limiting of its scope, the invention will be described and explained with additional specificity and detail through the use of the accompanying drawings, in which:

FIG. 1 is a schematic block diagram illustrating one embodiment of a system for gamification of an event;

FIG. 2 is a schematic block diagram illustrating one embodiment of an apparatus for gamification of an event;

FIG. 3 is a schematic block diagram illustrating one embodiment of another apparatus for gamification of an event;

FIG. 4 is a flow chart diagram illustrating one embodiment of a method for gamification of an event; and

FIG. 5 is a flow chart diagram illustrating one embodiment of another method for gamification of an event.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

The computer readable medium may also be a computer readable signal medium. A computer readable signal medium may include a propagated data signal with program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport program code for use by or in connection with an instruction execution system, apparatus, or device. Program code embodied on a computer readable signal medium may be transmitted using any appropriate medium, including but not limited to wire-line, optical fiber, Radio Frequency (RF), or the like, or any suitable combination of the foregoing

In one embodiment, the computer readable medium may comprise a combination of one or more computer readable storage mediums and one or more computer readable signal mediums. For example, program code may be both propagated as an electro-magnetic signal through a fiber optic cable for execution by a processor and stored on RAM storage device for execution by the processor.

Program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model. The computer program product may be stored on a shared file system accessible from one or more servers.

The computer program product may be integrated into a client, server and network environment by providing for the computer program product to coexist with applications, operating systems and network operating systems software and then installing the computer program product on the clients and servers in the environment where the computer program product will function.

In one embodiment software is identified on the clients and servers including the network operating system where the computer program product will be deployed that are required by the computer program product or that work in conjunction with the computer program product. This includes the network operating system that is software that enhances a basic operating system by adding networking features.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by program code. The program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

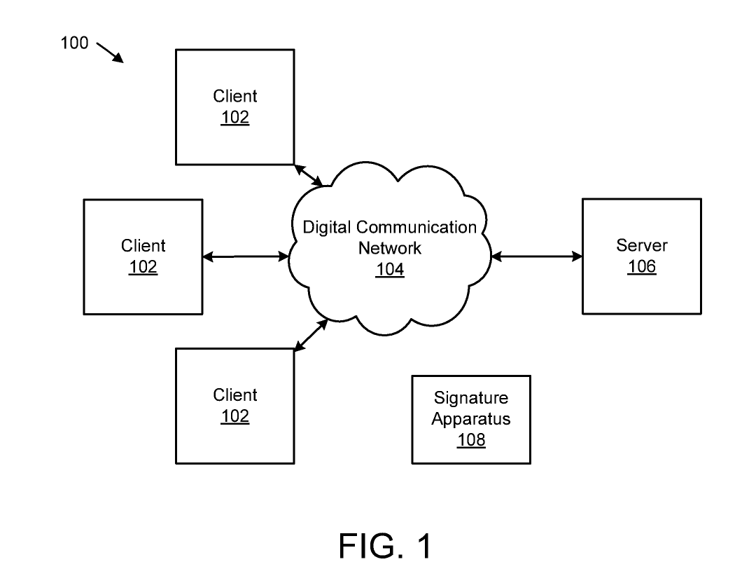

FIG. 1 depicts one embodiment of a system 100 for gamification of a system. In one embodiment, the system 100 includes clients 102, digital communication network 104, servers 106, and a signature apparatus 108, which are described below.

The clients 102, in certain embodiments, include mobile devices, such as laptops, tablet computers, smartphones, PDAs, and/or the like. In another embodiment the clients 102 include wearable devices, such as smart watches, head-mounted optical displays, and/or the like. In some embodiments, the clients 102 include one or more motion sensors, such as accelerometers, gyroscopes, magnetometers, and/or the like. In another embodiment, the clients 102 include location sensors, such as global positioning system (“GPS”) receivers, proximity sensors, and/or the like. The clients 102 may include electromagnetic field sensors, temperature sensors, and/or the like. In some embodiments, the clients 102 include one or more cameras, microphones, and/or the like. In certain embodiments, the sensors are persistently on and receiving input data. In another embodiment, the sensors are selectively turned on and off in response to input received from one or more sensors, user input, and/or the like.

The system 100 includes a digital communication network 104 that transmits digital communications related gamification of an event. The digital communication network 104 may include a wireless network, such as a wireless telephone network, a local wireless network, such as a Wi-Fi network, a Bluetooth® network, and the like. The digital communication network 104 may include a wide area network (“WAN”), a storage area network (“SAN”), a local area network (“LAN”), an optical fiber network, the internet, or other digital communication network known in the art. The digital communication network 104 may include two or more networks. The digital communication network 104 includes one or more servers, routers, switches, and other networking equipment. The digital communication network 104 may also include computer readable storage media, such as a hard disk drive, an optical drive, non-volatile memory, random access memory (“RAM”), or the like.

In certain embodiments, the system 100 includes servers 106. In one embodiment, a server 106 includes a main frame computer, a desktop computer, a laptop computer, a tablet computer, a smartphone, a cloud computer, and/or the like. In some embodiments, the clients 102 communicate with a server 106 through the digital communication network 104. In some embodiments, clients 102 receive data from the server 106 and/or store data on the server 106. In certain embodiments, the servers 106 store data related to gamification of an event, such as digital motion signatures, analysis algorithms, and/or the like. In another embodiment, the servers 106 perform some of the operations associated with gamification of an event, such as motion signature analysis, and/or the like.

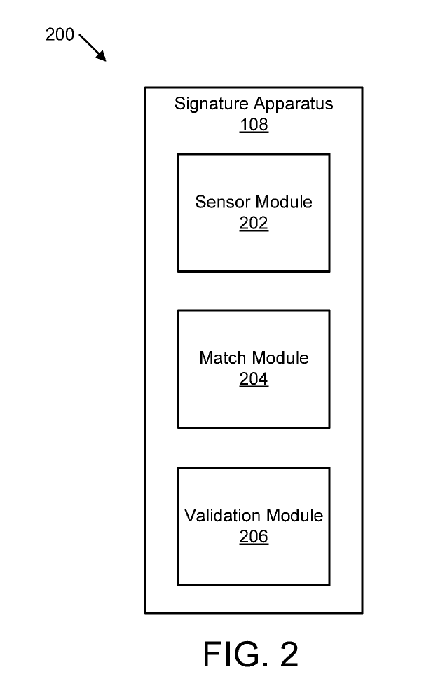

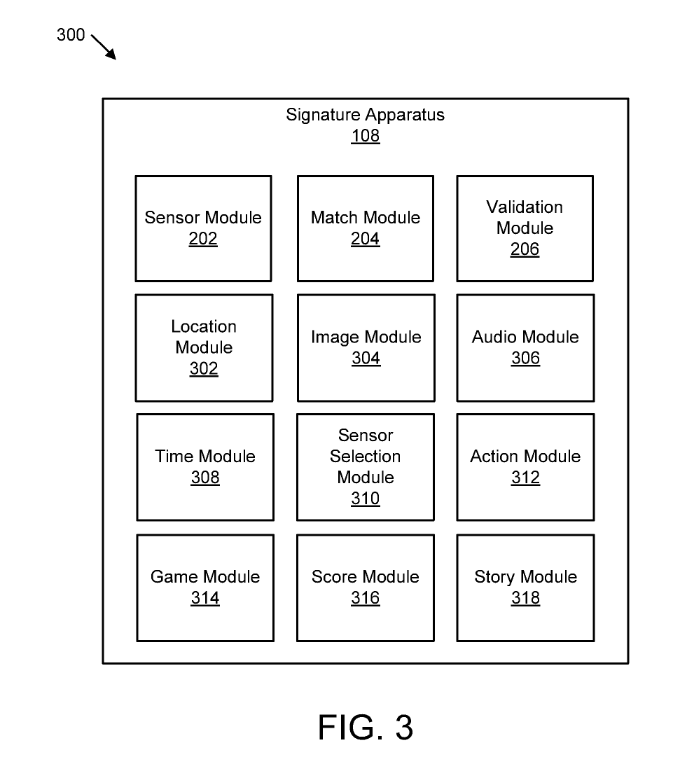

The signature apparatus 108, in certain embodiments, includes one or more modules that perform operations associated with gamification of an event. In one embodiment, the signature apparatus 108 generates a motion signature for an event, compares the generated motion signature with a predefined motion signature, and verifies the generated motion signature matches the predefined motion signature. In some embodiments, at least a portion of the signature apparatus 108 is located on the clients 102 and the server 106. The signature apparatus 108, and its accompanying modules, are described in more detail below with reference to FIGS. 2 and 3.

FIG. 2 depicts one embodiment of an apparatus 200 for gamification of an event. In one embodiment, the apparatus 200 includes an embodiment of a signature apparatus 108. The signature apparatus 108, in certain embodiments, includes a sensor module 202, a match module 204, and a validation module 206, which are described in more detail below.

The sensor module 202, in one embodiment, generates a motion signature associated with an event. In some embodiments, the event involves some kind of motion, such as a theme park ride, skiing, mountain biking, driving, and/or the like. The event typically is a repeatable event, such as an amusement park ride. In another example, an event is a generally repeatable event, such as a ski run where a user may ski the ski run and another user may ski the same ski run but in a different way. For example, the event may be something that multiple people can participate in even though they participate at different times. In certain embodiments, because the event involves motion, a motion signature may be derived from the event using a client 102 associated with a user performing the event. For example, a motion signature may be generated by a smartphone that is on the user's person while the person is riding a theme park ride. In such an embodiment, the sensor module 202 may use one or more motion sensors of the smartphone, such as an accelerometer or gyroscope, to generate a motion signature for the event. Thus, a motion signature generated by the sensor module 202 during a theme park ride may be associated with that specific theme park ride.

In some embodiments, the sensor module 202 generates a motion signature by recording one or more motion characteristics during performance of the event. The characteristics, in one embodiment, include speed, acceleration, centripetal force, and/or the like. For example, the sensor module 202 may generate a motion signature using motion data generated by an accelerometer, a gyroscope, or both. In some embodiments, a client 102 is placed in a motion signature recording mode such that the sensor module 202 begins generating a motion signature just prior to the start of an event.

In one embodiment, the sensor module 202 determines a type of event that a user is participating in. In another embodiment, the sensor module 202 uses other sensor information to determine the type of event, such as global positioning satellite (“GPS”) data, audio data, image data, electromagnetic field data, temperature data, and/or the like. Alternatively, the sensor module 202 receives an event type from a user.

In one embodiment, the sensor module 202 senses motion of the user based on movements of the entire body of the user rather than intentional movement of the signature apparatus 108 to control a game. For example, the signature apparatus 108 may be with the user, such as in a pocket, and the user may engage in an activity that involves physical movement of the user to participate in the event. Typically the event is not an event specific to the signature apparatus 108, but is an event in which users often participate without a signature apparatus 108, such as skiing, cycling, riding a ride in an amusement park, etc. The sensor module 202 may record a motion signature without the user specifically directing movement of the signature apparatus 108, but instead the recorded motion is sensed and recorded as the user participates in the event, for example, while the signature apparatus 108 is in a pocket of the user. Thus the signature apparatus 108 may differ significantly from a typical gaming controller where a user specifically moves and manipulates the gaming controller to elicit a response on a screen. In one embodiment, the sensor module 202 may ignore movements that may be associated with a user moving the mobile device with respect to the user's body, such as holding the mobile device in the user's hand and moving the mobile device.

In certain embodiments, in response to determining the type of event, the sensor module 202 places the client 102 in a signature recording mode. In one embodiment, a user manually places a client 102 in a signature recording mode. In some embodiments, a client 102 is automatically placed in a signature recording mode by the sensor module 202. The sensor module 202, in such an embodiment, uses one or more sensors of a client 102 in order to determine when to begin recording a motion event. In one embodiment, the sensor module 202 uses data from a GPS receiver, a proximity sensor, and/or the like to determine the location of a client 102, which may determine whether the sensor module 202 should begin motion recording. For example, the sensor module 202 may determine that a user is standing in line for an amusement park ride using data received by a GPS receiver. Based on the GPS data, the sensor module 202 may determine when the user is about to get on the ride and begin recording motion at that moment. Similarly, the sensor module 202 may stop recording motion when the sensor module 202 determines the user is finished riding the ride.

In another embodiment, the sensor module 202 uses an electromagnetic field sensor to help generate a signature of an event. For example, the electromagnetic field sensor may be used to determine the direction of north or to determine that the user is approaching an electric motor. In another embodiment, the sensor module 202 uses a temperature sensor to help generate a signature for an event. For example, the temperature sensor may measure a change from cold to warm temperature, which may indicate that the user has moved from outdoors to indoors during the winter, or the reverse during the summer. In one example, the sensor module 202 may use a cold temperature from a temperature sensor in conjunction with detected motion and possibly GPS information to identify that the user is skiing.

In certain embodiments, the sensor module 202 stores a generated motion signature on a client 102 that was used to generate the motion signature. In another embodiment, the sensor module 202 stores a generated motion signature on a server 106. In certain embodiments, the generated motion signature is stored in a motion signature library associated with a user. The motion signature library, in one embodiment, includes a plurality of motion signatures associated with a plurality of events. In some embodiments, the motion signature library organizes the motion signatures by event type, such as by a specific roller coaster, mountain biking hill/trail, ski slope, and/or the like.

The match module 204, in one embodiment, compares the generated motion signature with a predefined motion signature associated with an event. In certain embodiments, the predefined motion signature is stored in an event library, which includes a plurality of motion signatures where each predetermined motion signature is associated with an event. In another embodiment, the event library may include an event associated with multiple predefined signatures. For example, an event may include predefined signatures from various parts or activities of the event. In another embodiment, a predefined motion signature library is stored on a server 106, which is accessible to a client 102 through the digital communication network 104. In certain embodiments, the match module 204 finds a predefined motion signature in the event library by looking up a predefined motion signature based on the event. For example, a particular event may have a unique event ID that may be used as a key into a table of predefined motion signatures.

In one embodiment, the predefined motion signature includes a pre-recorded motion signature. For example, a motion signature may be recorded during performance of an event, as described above with reference to the sensor module 202. In another embodiment, the predefined motion signature comprises a synthetic motion signature generated using a mathematical algorithm, equation, simulation, and/or the like. For example, the match module 204 may use a formula, equation, etc. to generate a motion signature for an event like bicycling, waterskiing, rock climbing etc. Equations, algorithms, etc. may take into account typical speeds, locations, etc. to create a motion signature that may be used to compare with a generated motion signature.

In yet another embodiment, the predefined motion signature may be generated in real-time based on one or more algorithms, equations, simulations, etc. and/or output generated by one or more algorithms, equations, simulations, etc. In the embodiment, algorithms, equations, simulations, etc. may generate data during or after an event to compare to a generated motion signature. Thus, for example, the match module 204 may infer a motion signature by using algorithms, formulas, transformations, and/or the like, in real-time based on input received by the one or more sensors.

In one embodiment, the match module 204 compares the generated motion signature with the predefined motion signature in order to determine whether the motion signatures match. A validation module 206, in another embodiment, verifies that the user participated in the event by verifying that the generated motion signature matches the predefined motion signature from the library. In one embodiment, the validation module 206 determines whether one or more characteristics of the generated motion signature are within a predetermined threshold of one or more corresponding characteristics of the predefined motion signature.

For example, the validation module 206 may verify a generated motion signature matches a predefined motion signature by performing a probability analysis to determine the probability of the generated motion signature matching the predefined motion signature. In some embodiments, if the result of the probability analysis is within a predetermined probability threshold, the validation module 206 determines the generated motion signature matches the predefined motion signature. One of skill in the art will recognize other methods to compare two digital signatures.

In another embodiment, the validation module 206 verifies a generated motion signature matches a predefined motion signature by determining whether the signatures match in the time domain. Thus, the validation module 206 determines whether one or more characteristics of the signatures match over time. As described above, the validation module 206 may determine a probability and/or confidence of the signatures matching and whether the determined probability and/or confidence are within a predetermined threshold.

In another embodiment, the validation module 206 verifies a generated motion signature matches a predefined motion signature by determining whether the signatures match in the frequency domain. Thus, the validation module 206 determines whether one or more frequency characteristics of the signatures match. The sensor module 202 may record motion and/or other sensor readings and may identify frequency data from the readings. The match module 204 may compare frequency data from the generated motion or other sensor signatures with frequency data of a known event. The validation module 206, in such an embodiment, may use one or more mathematical transformations to transform signals between the time domain and the frequency domain. For example, the validation module 206 may use a Fourier transform, a wavelet transform, a mel-frequency cepstral transform, and/or the like. One of skill in the art will recognize various transformations that may be used.

In one embodiment, once the validation module 206 verifies that a generated motion signature matches a predefined motion signature, the apparatus 200 stores the generated motion signature in the event library. The match module 204 may use one or more previously stored predefined motion signatures along with the newly stored motion signature to compare with another generated motion signature. Adding more motion signatures may allow for more accurate verification of a match between a generated motion signature and stored predefined motion signatures. The match module 204 may merge various motion signatures associated with an event, may compare a generated motion signal with predefined motion signatures sequentially, and the like. One of skill in the art will recognize other ways to incorporate verified motion signatures for an event with previously stored predefined motion signatures.

FIG. 3 depicts one embodiment of an apparatus 300 for gamification of an event. In one embodiment, the apparatus 300 includes an embodiment of a signature apparatus 108. The signature apparatus 108, in certain embodiments, includes a sensor module 202, a match module 204, and a validation module 206, which are substantially similar to the sensor module 202, match module 204, and validation module 206 of FIG. 2. The signature apparatus 108, in certain embodiments, includes one or more of a location module 302, an image module 304, an audio module 306, a time module 308, a sensor selection module 310, an action module 312, a game module 314, a score module 316, and a story module 318, which are described in more detail below.

In one embodiment, the location module 302 determines the location of a client 102 by using the location service functionality of the client 102. For example, the location module 302 may use GPS functionality of a mobile device to determine the location of the mobile device. In certain embodiments, the generated motion signature includes one or more GPS coordinates that describe the location of the mobile device. In another embodiment, the location module 302 associates location data describing the location of a client 102 with the generated motion signature.

In another embodiment, the location module 302 determines a location of the client 102 using a digital communication network 104, such as a wireless network, a cellular network, etc. For example, a wireless network may be at a certain location with a particular range and the location module 302 may determine a location of the client 102 to be within a certain radius if the client 102 is communication with the wireless network. In another embodiment, the location module 302 determines a location of the client 102 using triangulation. For example, the location module 302 may use a cellular network that uses triangulation between cell towers to determine a location of the client 102 in communication with the cellular network. One of skill in the art will recognize other ways for the location module 302 to use a location service functionality of the client 102 to determine a location of the client 102.

In some embodiments, the location data received by the location module 302 is used as an identifier of an event. For example, the GPS coordinates may be used to determine the specific theme park ride that a user is on. In one embodiment, determining the location of the client 102 ensures that the generated motion signature is associated with the correct event, and, subsequently, that the correct predefined motion signature for the event is retrieved. In such an embodiment, the match module 204 uses the location data to determine the event in order to find a predefined motion signature associated with the event.

In order to retrieve the predefined motion signature, in some embodiments, the match module 204 compares the location data associated with a generated motion signature to location data stored in the event library and associated with the event. The validation module 206 may determine whether the location data are similar enough such that the generated motion signature and the predefined motion signature may be compared and analyzed. For example, the validation module 206 may verify that the user participated in the event comprises verifying that the generated motion signature matches the predefined motion signature and verifying that at least one of the determined locations matches a location associated with the predefined motion signature of the event.

In another embodiment, the apparatus 300 includes an image module 304 that captures one or more images with an image capture device operably coupled to the mobile device. The one or more captured images are associated with the event. In one embodiment, the one or more images include still photographs and/or video images. In another embodiment, the image module 304 captures one or more images associated with an event. For example, the image module 304 may capture an image of a sign, a landmark, and/or any other item that is characteristic of the event.

In some embodiments, the image module 304 associates one or more captured images of the event with the motion signature associated with the event. For example, the image module 304 may capture an image of a sign associated with a particular ski run. The image may be associated with the motion signature that is generated as the user skis. In such an embodiment, the captured image may be used as a secondary indication of the event. The match module 204, in some embodiments, uses one or more images captured by the image module 304 to determine the event associated with the generated motion signature and to retrieve a predefined motion signature associated with the event. For example, the match module 204 may compare the one or more captured images with one or more images stored in the event library and associated with the event where the event library includes a plurality of images associated with a plurality of events such that each image is associated with a predefined motion signature of an event.

In order to retrieve the predefined motion signature, in some embodiments, the match module 204 compares a captured image associated with a generated motion signature to a previously captured image associated with the predefined motion signature. The validation module 206 may determine whether the images are similar enough such that the generated motion signature and the predefined motion signature may be compared and analyzed. In another embodiment, the validation module 206 and/or the image module 304 may verify that the user participated in the event by verifying that the generated motion signature matches the predefined motion signature and by verifying that at least one of the one or more captured images matches an image of the event library and associated with the predefined motion signature of the event.

The audio module 306, in another embodiment, is configured to record one or more audio tracks. In some embodiments, the audio module 306 uses one or more audio capture devices, such as a microphone, operably coupled to a client 102 to record audio tracks. In one embodiment, the audio module 306 records one or more audio tracks associated with an event. For example, the audio module 306 may record an audio track that is characteristic of a particular event, such as a music track associated with a theme park ride, and/or the like.

In some embodiments, the audio module 306 associates one or more audio tracks of an event with the motion signature associated with the event. For example, the audio module 306 may record an audio track for a particular theme park attraction. The audio track may be associated with the motion signature that is generated as the user rides the attraction. In such an embodiment, the recorded audio track may be used as a secondary indication of the event. The match module 204, in some embodiments, compares the one or more captured audio tracks with one or more audio tracks stored in the event library and associated with the event and the event library may include a plurality of audio tracks associated with a plurality of events such that each audio track is associated with a predefined motion signature of an event.

In order to retrieve the predefined motion signature, in some embodiments, the match module 204 compares a recorded audio track associated with a generated motion signature to a previously recorded audio track associated with the predefined motion signature. The validation module 206 may verify that the user participated in the event by verifying that the generated motion signature matches the predefined motion signature and verifying that at least a portion of one of the one or more captured audio tracks matches at least a portion of an audio track associated with the predefined motion signature of the event by determining whether the audio tracks are similar enough such that the generated motion signature and the predefined motion signature are associated with the same event.

In another embodiment, the time module 308 associates a timestamp with the generated motion signature. The timestamp, in certain embodiments, specifies the time and/or date that the event occurred. In one embodiment, the time module 308 associates a timestamp with images captured by the image module 304, which indicates the time in which an image was taken. In some embodiments, the time module 308 also determines the duration of the event that generated the motion signature. The match module 204 may use the time data to retrieve a predefined motion signature and/or to verify the generated motion signature is associated with a particular event.

For example, a particular event, such as a particular theme park ride, may only be open during certain hours of the day such that the user may only ride the attraction during those hours. If the match module 204 determines that a generated motion signature for the ride was generated at a time outside the specified hours, based on the timestamp generated by the time module 308, the match module 204 can determine that the generated motion signature is invalid and discard it. In another embodiment, the time module 308 may include a time range for when a user may participate in the event and if the user participates in the event outside of the time range the validation module 206 may determine that the user has not complied with conditions for validation of the event. The time range may be during normal operating hours or may be outside of typical operating hours. For example, the apparatus 300 may be part of a game where a user may be required to participate in an event after typical hours, such as between midnight and 2 AM.

In one embodiment, the apparatus 300 combines use of various modules. For example, the sensor module 202, the match module 204, the validation module 206, the location module 302, the image module 304, and audio module 306, and the time module 308 may be used together in various combinations to determine if a user participated in an event. For example, where the sensor module 202 generates a motion signature, the location module 302 determines a location, the image module 304 generates one or more images, the audio module 306 generates one or more audio tracks, and the time module 308 generates a time stamp, the match module 204 and the validation module 206 may use the generated motion signal in combination with one or more other types of data from the modules 302-308 to verify participation of the user in the event. In one example, all types of data must match data in the event library. In another example, a subset of matches is required. For instance, if the generated motion signature matches a predefined motion signature and a generated image matches an image in the event library associated with the event, the validation module 206 may verify participation of the user in the event even though one or more audio generated tracks do not match stored audio tracks associated with the event.

In a further embodiment, the sensor selection module 310 determines the one or more sensors to be used based on the event. In one embodiment, the sensor selection module 310 determines the location of a user using the location module 302 and, based on the determined location, determines the best sensors to be used to generate the motion signature. For example, the sensor selection module 310 may determine that the accelerometer and the camera of a mobile device may be best for a particular theme park ride. For a different ride, however, the sensor selection module 310 may determine that the accelerometer and the microphone are better suited for a different ride. In this manner, the sensor selection module 310 determines the best way to identify the event and to generate an accurate motion signature for the event.

In certain embodiments, the one or more sensors are persistently on. In another embodiments, the sensor selection module 310 selectively turns one or more sensors on and off in response to determining the sensors that should be used. For example, based on determining that the user is at an amusement park ride that goes underground (e.g., by receiving location data from the GPS sensor), the sensor selection module 310 may determine that a GPS sensor is an appropriate sensor and enables the GPS sensor until the ride is complete. In another example, the sensor selection module 310 turns on a temperature sensor may be useful and the sensor selection module 310 may enable the temperature sensor during an event.

In one embodiment, an action module 312 performs one or more actions in response to verifying the motion signatures match. In one embodiment, the action module 312 increases a user's score associated with a game by a predetermined amount, as described below with reference to the score module 316. In another embodiment, the action module 312 checks a requirement off a to-do list, a list of items for a scavenger hunt, or the like. In a further embodiment, the action module 312 shares the event on a social network, such as Twitter®, Facebook®, Instagram®, or the like, by posting a message, photo, video, or the like about the event. In a further embodiment, the action module 312 updates a leaderboard for a game associated with the event. The action module 312, in another embodiment, reveals the next step, direction, task, or the like, associated with a puzzle game.

The signature apparatus 108, in some embodiments, may be used as part of a gamification system. In one embodiment, a game module 314 presents one or more games that include one or more events. In one embodiment, the game module 314 provides an achievement type game where a user is given points, awards, badges, or the like, for participating in certain events. For example, in an amusement park themed game, one of the achievements may require the user to ride four rollercoasters in order to earn an achievement. The signature apparatus 108, in one embodiment, can be used to ensure that the user actually rode a particular rollercoaster. The sensor module 202, in one embodiment, generates a motion signature for the rollercoaster, a match module 204 compares the generated motion signature to a predefined motion signature, and the validation module 206 verifies that the motion signatures match.

In a further embodiment, secondary information may also be used to ensure the user actually participated in the event, such as location data received by the location module 302, images captured by the image module 304, audio recorded by the audio module 306, and timing information provided by a time module 308. In this manner, the signature apparatus 108 may be used for various games that involve motion events, such as skiing, hiking, mountain biking, theme parks, and/or the like to ensure a user is actually participating in the event.

In one embodiment, the game module 314 presents video, images, audio, or the like through the client 102 to a user to present a story, rules, clues, and/or other elements of a game. For example, the game module 314 may present a portion of a game in the form of a story with video and audio and then as the user completes certain events, the sensor module 202, the match module 204, and the validation module 206 may determine if the user completed a next step in the game. Where the validation module 206 determines that the user participated in the first event, the game module 314 may present a second scenario of the story on the mobile device. The sensor module 202, the match module 204, and the validation module 206 may then validate user participation in a second event associated with the second scenario. The game module 314, in one embodiment, downloads a game from a website for use by the user. In another embodiment, the game module 314 uses data and information from a website and data is streamed to the client 102 from the website. In another embodiment, the game module 314 connects with other users with clients 102 for a game that involves multiple users in competition and/or collaboration.

In certain embodiments, a score module 316 tracks a user's scores, points, achievements, badges, and/or the like that a user receives by participating in events associated with one or more games. In certain embodiments, the score module 316 stores the user's score data on the server 106, which may be accessible by one or more clients 102. In certain embodiments, the score module 316 organizes scores generated by a plurality of clients 102 such that a user can determine how their scores compare to other users playing a game. For example, the score module 316 may maintain a leaderboard for users playing a game. In some embodiments, the score module 316 creates an overall leaderboard that tracks users' scores across all games. In another embodiment, the score module 316 creates a leaderboard for each event.

In another embodiment, a story module 318 provides a story associated with one or more events. The story, in some embodiments, includes one or more scenarios associated with an event. In some embodiments, the scenarios are presented sequentially based on a user fulfilling the requirements of a previous scenario. Thus, the user may not see upcoming scenarios until a current scenario is accomplished. In another embodiment, the story may provide a user with more than one possible scenario at the same time such that upcoming scenarios are dependent on the current scenario the user chooses. In one embodiment, a story may include game elements provided by the game module 314.

In certain embodiments, the story module 318 downloads a story that includes one or more events. In another embodiment, the story module 318 associates events with more than one story. In one example, the story module 318 may receive a story associated with an amusement park on the user's mobile device. The story may include graphics, images, maps, music, animations, clues, riddles, and/or the like. The story may direct the user to a first amusement park ride. As the user travels to the ride, the story may provide narration, information, or the like regarding the amusement park, places within a proximity to the user, or the like.

In certain embodiments, the story module 318 requires the user to participate in an event in order to continue the story. Thus, continuing with the previous example, the story module 318 may receive confirmation from the validation module 206 that the user did ride the amusement park ride as directed by the story. The sensor module 202 may generate a motion signature associated with the ride, the match module 204 may compare the generated motion signature to a predefined motion signature, and the validation module 206 may verify that the generated motion signature matches the predefined motion signature. Thus, upon receiving confirmation, the story module 318 may continue the story, which may direct the user to travel to another amusement park ride, restaurant, gift shop, novelty shop, or the like. In other embodiments, the story module 318 may provide one or more stories associated with a variety of event locations, such as a museum, a gym, a ski resort, a national park, and/or the like.

In one embodiment, the story module 318 presents a shared story that includes a plurality of users, with each user having a mobile device. In one embodiment, the mobile devices communicate through a digital communication network 104 to share the story. In another embodiment, a server 106 coordinates the story among the plurality of users. In certain embodiments, the users collaborate and work together as a team to advance a shared story. For example, the story may involve a game, such as a scavenger hunt, that requires each user to go find an item at a particular location and bring it back to a central location. Alternatively, the story may include challenges, puzzles, riddles, or the like that the users may try to solve collaboratively. In another example, the story may include visiting famous locations around the world. The users may be located in different areas of the world and advance the story by visiting locations in their respective areas of the world. Thus, advancement of the story depends on the actions of each of the several users.

In one embodiment, the story module 318 advances a shared story in response to each user participating in an event. For example, the story module 318 may require each user of a shared story to ride the same theme park ride, ride a different theme park ride, visit different attractions, or the like. Each user, in certain embodiments, gets a different perspective of the story depending on what they have done and what other users have done. For example, a user may proceed at certain points through a story alone, but their progress may be dependent on the actions of one or more different users. Thus, even though the user is alone at points in the story, the user may need to collaborate with other users of the shared story to advance.

In another embodiment, the story module 318 provides a portion of a story where a user may engage in multiple events. The user may then choose an event and the sensor module 202 may generate a motion signature associated with the event, the match module 204 may compare the generated motion signature to a predefined motion signature, and the validation module 206 may verify that the generated motion signature matches the predefined motion signature of the event. The story module 318 may then present another portion of the story based on the event in which the user participated where the presented portion of the story differs based on the event selected by the user. In another embodiment, the story module 318 changes the story based on the chosen event so that various combination of events will be associated with different versions of the story. In another embodiment, the story module 318 includes branches to a story and user participation in events determine which branch of the story that the story module 318 presents. One of skill in the art will recognize other embodiments of a story module 318 that modify a story, present different portions of a story, etc. based on user selection of events.

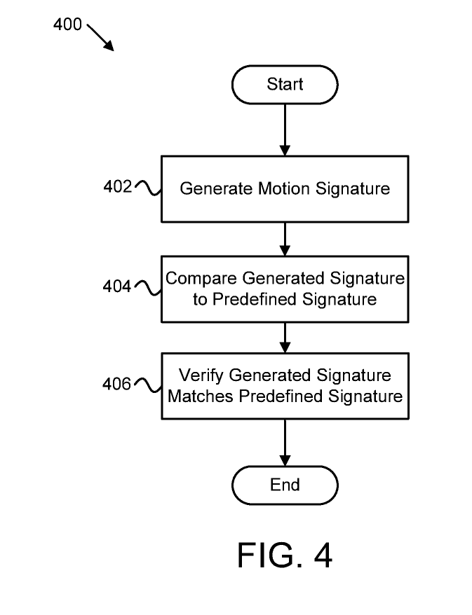

FIG. 4 depicts one embodiment of a method 400 for gamification of an event. In one embodiment, the method 400 begins and generates 402 a motion signature associated with an event. For example, the sensor module 202 may generate 402 the motion signature. The method 400 compares 404 the generated motion signature with a predefined motion signature associated with the event. In another embodiment, a match module 204 compares 404 the generated motion signature with a predefined motion signature. The method 400 verifies 406 that the user participated in the event by verifying that the generated motion signature matches the predefined motion signature, and the method 400 ends. A validation module 206, in one embodiment, verifies that the generated motion signature matches the predefined motion signature.

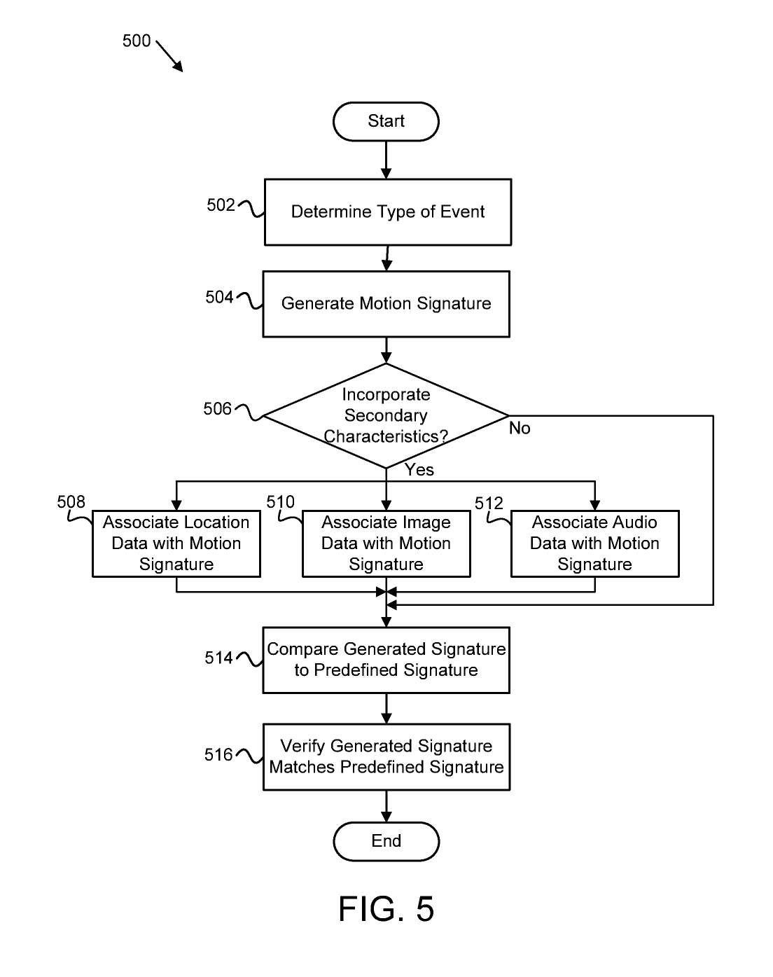

FIG. 5 depicts one embodiment of another method 500 for gamification of an event. In one embodiment, the method 500 begins and determines 502 a type of event that a user is participating in. In one embodiment, the sensor module 202 determines 502 the type of event. The method 500 may use secondary information to determine the type of event, such as GPS data, audio data, image data, and/or the like. Alternatively, the method 500 receives an event type from a user. In another embodiment, the method 500 generates 504 a motion signature associated with the determined event. In certain embodiments, the method 500 generates a motion signature by recording one or more motion characteristics during performance of the event, such as speed, acceleration, centripetal force, and/or the like.

In a further embodiment, the method 500 determines 506 whether to include one or more secondary information into the motion signature, such as location data, images, audio tracks, timestamps, and/or the like. If the method 500 determines 506 to include secondary characteristics, the method 500 may associate 508 location data with the motion signature. The method 500 may determine the location of a client 102 using the location service of the client 102, such as a GPS service. In such an embodiment, the location data includes GPS coordinates, which would be associated with the generated motion signature. In one embodiment, the location module 302 determines a location of the client 102.

In another embodiment, the method 500 associates 510 one or more captured images of the event with one or more stored images associated with the event. For example, the image module 304 may generate one or more images and may associate 510 the captured images with the event by comparing the captured images with stored images associated with the event. In certain embodiments, the method 500 uses an image capture device operably coupled to a client 102 to capture one or more images. In one embodiment, the one or more images include still photographs and video images associated with an event, such as signs, landmarks, and/or the like. The method 500 may associate 512 a timestamp with the event, with the location, with the generated motion signature, captured images, etc. In certain embodiments, the time module 308 associates a timestamp with a captured image, a location, the generated motion signature, etc.

In a further embodiment, the method 500 associates 512 one or more recorded audio tracks of an event with the event. In one embodiment, the audio module 306 associates 512 one or more audio tracks with the event. For example, the method 500 may record an audio track that is characteristic of a particular event, such as a music track associated with a theme park ride, and/or the like. In some embodiments, the method 500 uses one or more audio capture devices, such as a microphone, operably coupled to a client 102 to record audio tracks. In certain embodiments, a time module 308 associates a timestamp with an audio track.

In one embodiment, the method 500 compares 514 the generated motion signature, including any secondary information associated with the motion signature, with a predefined motion signature. In one example, the match module 204 compares 514 the generated motion signature with a predefined motion signature. In certain embodiments, the predefined motion signature is stored in an event library, which comprises a plurality of motion signatures. In certain embodiments, the method 500 finds a predefined motion signature in the event library by looking up a predefined motion signature based on the event.

In another embodiment, the method 500 verifies 516 that the user participated in the event by verifying that the generated motion signature matches the predefined motion signature from the event library, and the method 500 ends. For example, the validation module 206 may verify that the generated motion signature matches the predefined motion signature from the event library. In certain embodiments, the method 500 determines whether one or more characteristics of the generated motion signature are within a predetermined threshold of one or more corresponding characteristics of the predefined motion signature. In another embodiment, the method 500 performs a probability analysis to determine the probability of the generated motion signature matches the predefined motion signature.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
generating a motion signature associated with an event, the motion signature generated on a mobile device with a user during the event, the mobile device comprising one or more sensors configured to detect motion;
comparing the generated motion signature with a predefined motion signature associated with the event, the predefined motion signature stored in an event library comprising a plurality of predefined motion signatures, each predefined motion signature associated with an event; and
verifying the user participated in the event by verifying that the generated motion signature matches the predefined motion signature of the event.

2. The method of claim 1, wherein verifying the generated motion signature matches the predefined motion signature comprises performing a probability analysis, wherein the motion signatures match in response to a result of the probability analysis being within a predetermined threshold.

3. The method of claim 1, wherein the one or more sensors comprise motion sensors and the motion sensors comprise one or more of an accelerometer, a magnetometer, and a gyroscope.

4. The method of claim 1, further comprising:
determining a location of the mobile device using device location functionality of the mobile device, wherein the generated motion signature is associated with one or more locations;
comparing the determined location with one or more locations stored in the event library and associated with the event, the event library comprising a plurality of locations associated with a plurality of events wherein each location is associated with a predefined motion signature of an event; and
wherein verifying the user participated in the event comprises verifying that the generated motion signature matches the predefined motion signature and verifying that at least one of the determined locations matches a location associated with the predefined motion signature of the event.

5. The method of claim 1, further comprising:
capturing one or more images with an image capture device operably coupled to the mobile device, wherein the one or more captured images are associated with the event;
comparing the one or more captured images with one or more images stored in the event library and associated with the event, the event library comprising a plurality of images associated with a plurality of events wherein each image is associated with a predefined motion signature of an event; and
wherein verifying the user participated in the event comprises verifying that the generated motion signature matches the predefined motion signature and verifying that at least one of the one or more captured images matches an image of the event library and associated with the predefined motion signature of the event.

6. The method of claim 1, further comprising:
capturing one or more audio tracks using an audio capture device operably coupled to the mobile device, wherein the one or more captured audio tracks are associated with the event;
comparing the one or more captured audio tracks with one or more audio tracks stored in the event library and associated with the event, the event library comprising a plurality of audio tracks associated with a plurality of events wherein each audio track is associated with a predefined motion signature of an event; and
wherein verifying the user participated in the event comprises verifying that the generated motion signature matches the predefined motion signature and verifying that at least a portion of one of the one or more captured audio tracks matches at least a portion of an audio track associated with the predefined motion signature of the event.

7. The method of claim 1, further comprising selecting a sensor of the one or more sensors based on a type of event experienced by the user.

8. The method of claim 1, further comprising determining a timestamp for the event, wherein the timestamp is associated with the motion signature.

9. An apparatus comprising:
a sensor module that generates a motion signature associated with an event, the motion signature generated on a mobile device with a user during the event, the mobile device comprising one or more sensors configured to detect motion;
a match module that compares the generated motion signature with a predefined motion signature associated with the event, the predefined motion signature stored in an event library comprising a plurality of predefined motion signatures; and
a validation module that verifies that the user participated in the event by verifying that the generated motion signature matches the predefined motion signature of the event.

10. The apparatus of claim 9, further comprising a story module that presents a first scenario of a story on a mobile device of a user, the first scenario associated with the event and is presented to the user prior to the sensor module generating the motion signature.

11. The apparatus of claim 10, wherein the event is a first event and a second scenario of the story is presented on the mobile device in response to verifying the generated motion signature matches the predefined motion signature for the first event, the second scenario associated with a second event, the sensor module, the match module and the validation module verify that the user participated in the second event.

12. The apparatus of claim 10, wherein the story comprises a shared story involving a plurality of users, the story being advanced in response to each of the plurality of users participating in an event.

13. The apparatus of claim 10, wherein the story module presents a plurality of events for the user to choose, wherein the story module comprises multiple story scenarios and a presented story scenario depends on which event is chosen by the user, wherein after the validation module verifies user participation in an event the story module presents a story scenario corresponding to the event verified by the validation module and chosen by the user.

14. The apparatus of claim 9, further comprising a game module that presents a game associated with one or more events, the game being played by participating in the one or more events, wherein participation is determined based on generated motion signatures.

15. The apparatus of claim 14, further comprising a score module that tracks the user's scores associated with the game, the user's scores being compared with other users' scores for the game.

16. The apparatus of claim 9, wherein the predefined motion signature comprises a pre-recorded motion signature for the event.

17. The apparatus of claim 9, wherein the predefined motion signature comprises one of:
a synthetic motion signature for the event, the synthetic motion signature being generated based on one or more of a mathematical formula, an algorithm, and a simulation; and
a motion signature generated in real-time during the event.

18. The apparatus of claim 9, further comprising an action module that performs one or more actions in response to verifying the generated motion signature matches the predefined motion signature.

19. A computer program product for verifying user participation, the computer program product comprising a computer readable storage medium having program code embodied therein, the program code executable by a processor for:
generating a motion signature associated with an event, the motion signature generated on a mobile device with a user during the event, the mobile device comprising one or more sensors configured to detect motion;
comparing the generated motion signature with a predefined motion signature associated with the event, the predefined motion signature stored in an event library comprising a plurality of predefined motion signatures; and
verifying the user participated in the event by verifying that the generated motion signature matches the predefined motion signature of the event.

20. The computer program product of claim 19, the program code further configured for:
presenting a game associated with one or more events, the game being played by participating in the one or more events, wherein participation is determined based on generated motion signatures; and
tracking the user's scores associated with the game, the user's scores being compared with other users' scores for the game.
